(19) United States
(12) Patent Application Publication
(10) Pub. No.: US 2008/0177581 A1
(43) Pub. Date: Jul. 24, 2008

(54) METHOD AND SYSTEM FOR PROVIDING QUOTES TO REPLACE INSURED ITEMS

(76) Inventor: Charles Kurt Artinger, Belleville, IL (US)

Correspondence Address: Patrick W. Rasche;Armstrong Teasdale LLP, Suite 2600, One Metropolitan Square, St. Louis, MO, 63102, US

(21) Appl. No.: 11/781,675

(22) Filed: Jul. 23, 2007

Related U.S. Application Data
(63) Continuation-in-part of application No. 11/064,639, filed on Feb. 24, 2005.
Application No. 11/064,639 is a continuation-in-part of application No. 09/732,591, filed on Dec. 8, 2000, now Pat. No. 6,873,958.

(51) Int. Cl. G06Q 40/00; G06Q 30/00; G06Q 10/00

(52) U.S. Cl. 705/4

(57) ABSTRACT

A web-based method for identifying items to replace insured items includes receiving item specification information from at least one of a user, a manufacturer, a distributor, a system administrator, and an authorizing agent, and utilizing a server to compare the received specification information with pre-stored information. The method also includes selecting at least one item which matches the received specification information and downloading information to the user related to the item to provide a replacement quotation.

### CROSS REFERENCE TO RELATED APPLICATIONS

This application is a continuation-in-part of U.S. patent application Ser. No. 11/064,639 filed Feb. 24, 2005, which is a continuation-in-part of U.S. Pat. No. 6,873,958, issued Mar. 29, 2005, both of which are assigned to the same assignee of the present invention, and both of which are hereby incorporated by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

This invention relates generally to computer network-based systems and more particularly to a network-based method and system for providing quotes for replacement of insured items.

Items of value are typically insured with insurance companies to offset the cost of replacing the item if an event occurs such that the item needs replacing. For example, jewelry is often insured to enable an owner to offset the cost of replacing the jewelry in the event the jewelry is lost, damaged, or stolen. Typically, after such an event occurs, the owner contacts the insurance company and files a claim to have the jewelry replaced. To file the claim, the owner typically files proof of ownership of the jewelry, often using a receipt that shows a purchase date and an amount of purchase of the jewelry and/or appraisal of the jewelry.

The claim is evaluated by a claims adjuster to determine a value of the originally-insured jewelry in comparison to the value of the insured property and either the owner, the insurance company, or both attempt to find a suitable replacement. The insurance company's responsibility to the insured, according to the policy, may be to repair or replace the insured item at the insurance company's cost, which may be a lower price than the insured amount. The claims adjuster also compares the proposed suitable replacement costs and repair costs, if applicable, to the value of the insured item. Often the process may be cumbersome or time-consuming, and may require many interactions between the insurance company and the owner, the insurance company and third parties, and/or the owner and the third parties. Eventually either the owner is issued a check to purchase the replacement item, or the insurance company issues a check directly to a merchant offering the replacement item for sale.

### BRIEF DESCRIPTION OF THE INVENTION

In an exemplary embodiment a method for replacing insured items using a web-based system including a server and at least one device connected to the server via a network is provided. The method includes the steps of receiving at the server, from an insurer, specification information about the item to be replaced, comparing the received item specification information with potential replacement product information pre-stored within the server, selecting at least one potential replacement product which substantially matches the received item specification information, and downloading item feature information, product accessory information, and a price quote related to the selected potential replacement product. The method further includes determining a settlement price for the insured item based on at least one of the potential replacement products, whose information was downloaded.

In another aspect a system for facilitating selection of an item by an insured user to replace an insured item of the insured user is provided. The system includes a device and a server connected to the device and configured to receive specification information data from an insurer about the item to be replaced via the device. The specification information includes at least one of a feature of the item, an accessory of the item, and a price quote. The server is further configured to identify stored product information data that substantially matches item specification information data entered into the server, and download potential replacement product information. The system is further configured to determine a settlement price for the insured item based on at least one of the potential replacement products, whose information was downloaded.

### BRIEF DESCRIPTION OF THE DRAWINGS

FIG. 1 is an exemplary system block diagram;

FIG. 2 is an exemplary flow diagram of a web-based method for selecting and quoting a price for replacement insured items;

FIG. 3 is an exemplary jewelry claim profile page that may be used to implement the method shown in FIG. 2;

FIG. 4 is an exemplary quote worksheet page that may be used to implement the method shown in FIG. 2;

FIG. 5 is an exemplary product menu selection page that may be used to implement the method shown in FIG. 2;

FIG. 6 is an exemplary product menu page, displaying loose diamonds, that may be used to implement the method shown in FIG. 2;

FIG. 7 is an exemplary product menu page, displaying loose diamonds results, that may be used to implement the method shown in FIG. 2;

FIG. 8 is an exemplary quote worksheet page, displaying comparable replacement products, that may be used to implement the method shown in FIG. 2;

FIG. 9 is another exemplary quote worksheet page, displaying comparable replacement products, that may be used to implement the method shown in FIG. 2;

FIG. 10 is an exemplary jewelry claim profile page, displaying comparable products, that may be used to implement the method shown in FIG. 2;

FIG. 11 is exemplary jewelry claim profile page, displaying comparable products, that may be used to implement the method shown in FIG. 2.

### DETAILED DESCRIPTION OF THE INVENTION

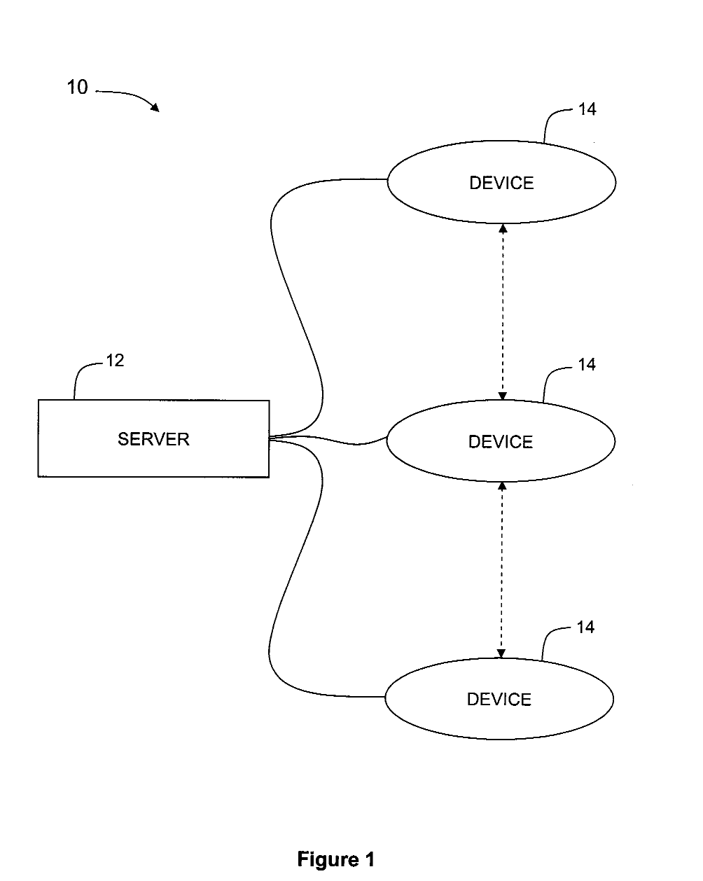

FIG. 1 is a block diagram of a system 10 in accordance with one embodiment of the present invention. System 10 includes a server 12 and a plurality of devices 14 connected to server 12. In one embodiment, devices 14 are computers including a web browser, and server 12 is accessible to devices 14 via the Internet. In an alternative embodiment, devices 14 are servers for a network of customer devices.

Devices 14 are interconnected to the Internet through many interfaces including through a network, such as a local area network (LAN) or a wide area network (WAN), through dial-in-connections, cable modems and special high-speed ISDN lines. Alternatively, devices 14 could be any device capable of interconnecting to the Internet including a web-based phone or other web-based connectable equipment. A database providing item information is stored on server 12 and can be accessed by potential customers at one of devices 14 by logging onto server 12 through one of devices 14.

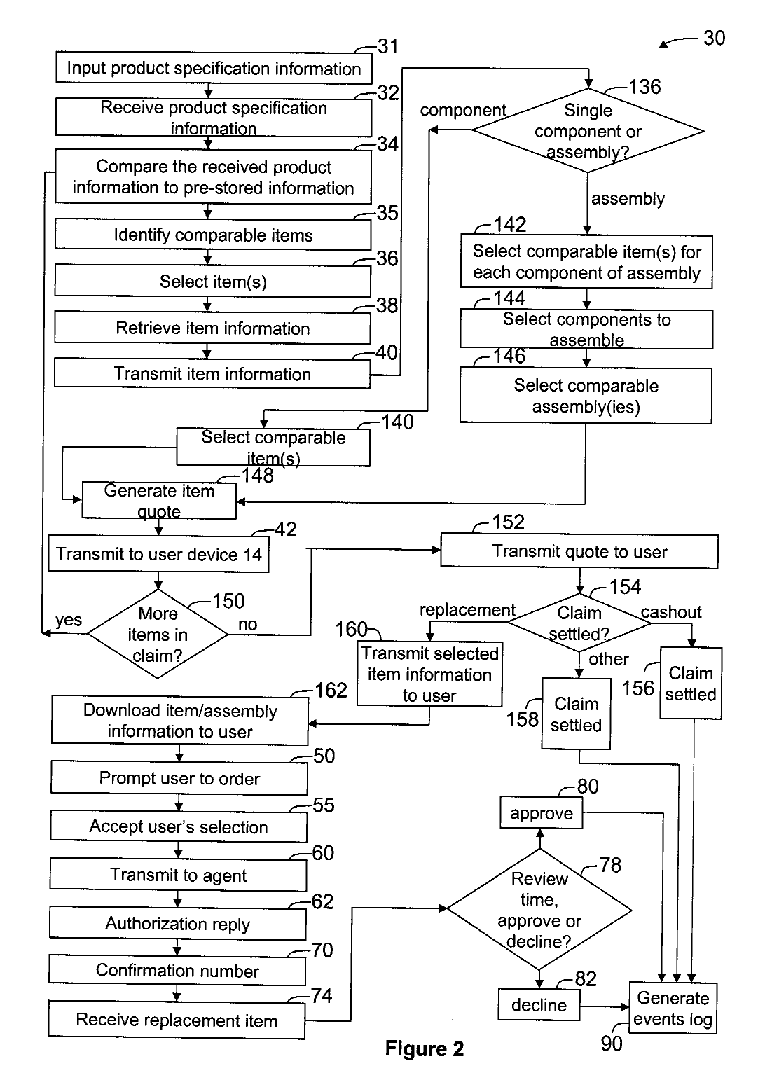

FIG. 2 is a flow diagram 30 for a web-based method for selecting and quoting a price for items (not shown) that may be used to replace insured items for which a claim has been made. In an exemplary embodiment, the items include, but are not limited to, jewelry items. Alternatively, the items include any item eligible for insurance coverage and potentially replaceable when insurance claims are filed, such as, but not limited to, home furnishings, and/or automobiles.

Initially, a user, such as, but not limited to, an insurance agent, an insured, or a third party, inputs 31 product specification information into system 10. Product specification information is received 32 from a user, i.e. a third party user. In one embodiment, the user inputs or submits the information into a device, such as device 14 (shown in FIG. 1), which transmits the information to a server, such as server 12 (shown in FIG. 1). In the exemplary embodiment, the product specification information is received 32 from the user via a multi-query interface (not shown in FIG. 2), as will be described in greater detail below.

The product specification information received 32 includes an identification of item features and an identification of any applicable accessories for the item, as will be described in more detail below. In the exemplary embodiment, the item features may include, but are not limited to including, jewelry material information, such as, but not limited to the type of metal, gem stone shape, gem stone weight, gem stone color, and gem stone clarity. Additional features include, but are not limited to, secondary gem stone types, secondary gem stone colors, secondary gem stone weight, and secondary gem stone clarity.

The received information is compared 34 to pre-stored information. In one embodiment, the pre-stored information is stored in a database that is accessible by server 12. The pre-stored information includes item features and accessories information. The received information is compared 34 to the pre-stored information to determine if any items contained in the pre-stored information satisfy the product specifications submitted. In addition, the information received is compared 34 to pre-stored information to assess the suitability of the product. In the exemplary embodiment, the received information is compared 34 to pre-stored information to determine whether a resulting product having the received product specifications is capable of meeting parameters of the indicated product defined by the user. For example, in one embodiment, the received information is compared 34 to pre-stored information to determine whether accessories are available for the selected item configuration. In the exemplary embodiment, the pre-stored information is information based on an item, such as, for example, a jewelry item, for sale at the time of the comparison 34.

If the product resulting from the received information does not meet the parameters of the intended item, in the exemplary embodiment, system 10 guides the user by providing suggestions for a correct item configuration. In an alternative embodiment, system 10 guides the user by providing information regarding alternative products that may be compatible with the item parameters supplied by the user. In a further alternative embodiment, system 10 prompts the user by providing information regarding products that are potential upgrades for the item parameters supplied by the user.

Pre-stored item information is then identified 35 that substantially matches the information entered by the user and then those items pertaining to that pre-stored information are selected 36. In the exemplary embodiment, item information pertaining to the selected items is then retrieved 38 by system 10. In one embodiment, the item information retrieved 38 includes an item identifier description and an associated price for each selected item. For example, in one embodiment, the item identifier description is a jewelers' description suitable for insurance quotes, and the price represents a retail price of the product. The price may also represent a settlement or “cash buyout,” or “cash-out,” price available to the insured member if the insured member elects to receive a monetary settlement payment, rather than a suitable replacement. Server 12 then transmits 40 the retrieved items, identifier number, and associated prices information to user device 14, such that the user can view the information and potential alternative selections.

The user may use the retrieved product information to determine 136 whether a single component or an assembly of components may be used as a suitable replacement item for the insured item. If a single component must be replaced, the user selects 140 a comparable item or comparable items based on the retrieved product information transmitted 40. In one embodiment, if the user determines 136 a single component may be used as a replacement item, the user selects 140 a comparable stone or stones from the information transmitted 40. In the exemplary embodiment, system 10 uses the price information from the selected item, or selected items, to generate 148 a quotation or replacement cost estimate for each selected item including the indicated features and accessories, and server 12 then transmits 42 the retrieved item identifier descriptions and the quotation to user device 14. In the exemplary embodiment, the generated quote is based on items, such as, but not limited to, jewelry items, available for sale at the time the quote is generated 148. Alternatively, the generated quote is based on items, such as, but not limited to, jewelry items, that are not available for sale at the time the quote is generated 148.

If the user determines 136 that an assembly of components may be used as a replacement item for the insured item, the user may create a comparable assembly or assemblies by using the information transmitted 40 to select 142 a comparable item or items for each component of an assembly. More specifically, in one embodiment, the user may select replacement options for a loose stone and a setting for the stone. Moreover, custom items may be entered as a component of an assembly. For example, the cost of labor may be entered as a custom item. Alternatively, or additionally, other expenses not found in the information transmitted 40 may be entered as a custom item. When at least one item has been selected 142 for each component of a replacement assembly, the user selects 144 the items to assemble into a comparable assembly. In the exemplary embodiment, the user may create more than one comparable assembly by selecting 144 a combination of items from the transmitted 40 information. The user may then select 146 one or more comparable assemblies to receive an item replacement quote. In the exemplary embodiment, system 10 uses the price information associated with the selected 146 item or items to generate 148 a quotation or replacement cost estimate for each selected assembly including the indicated features and accessories, and server 12 then transmits 42 the retrieved item identifier descriptions and the quotation to user device 14. In the exemplary embodiment, the generated quote is based on items, such as, but not limited to, jewelry items, available for sale at the time the quote is generated 148. Alternatively, the generated quote is based on items, such as, but not limited to, jewelry items, that are not available for sale at the time the quote is generated 148.

If a claim includes more than one insured item, the user may repeat 150 the above steps, starting with comparing 34 the received information to accessible pre-stored information, to generate 148 at least one quote for each insured item in the claim. In the exemplary embodiment, after system 10 generates 148 a quote or quotes for replacing an insured item or items, server 12 then transmits 152 the quotation information to an agent user device 14. The user, i.e. an insurance agent, may then use the quotation information to settle the claim made by an insured by replacing the item 154. In the exemplary embodiment, the insured member may choose to replace the insured item. Alternatively, the insured may choose to settle the claim by “cashing out” 156 based on the quotation information or choose to settle the claim using another form of claim settlement 158.

In one embodiment, if that claim is settled by replacing the insured item or items 154, server 12 then transmits 160 the selected 140 and/or 146 items identifier number and associated prices and downloads 162 the retrieved information to the user device to enable the insured to view the information and potential alternative selections for replacement. In such an embodiment, system 10 then prompts 50 the insured to select one or more of the selected products downloaded 162. If the user is a registered user, system 10 accepts orders online by providing the user a purchase order form and then receives the completed purchase order form from the user. The completed purchase order form is then authenticated against pre-determined criteria to determine whether system 10 should accept 55 the completed purchase order form.

If the purchase order form is accepted 55, the order is then transmitted 60 to an authorized agent of the insurance company. In one embodiment, system 10 is interconnected with a plurality of authoring agents representing a plurality of insurance companies. In one embodiment, the purchase order is transmitted 60 automatically via e-mail and/or through a facsimile to the authorizing agent.

After the authorized agent has reviewed the purchase order to ensure that the item selected is suitably compatible, the authorized agent submits 62 an authorization reply to system 10, and system 10 automatically prints a hard-copy of the purchase order, and e-mails and/or faxes at least one of a manufacturer and a distributor a copy of the purchase order including shipping instructions. The manufacturer or the distributor receiving the purchase order fills the purchase order and inputs 70 a confirmation number and a shipping tracking number into system 10. In one embodiment, system 10 is compatible with shipment tracking software in use, such as, but not limited to, Federal Express Company, United Parcel Service, Airborne Express, and the United States Postal Service.

After the user has received 74 the replacement item, system 10 includes an integrated time accounting system that affords the user a period of time 78 to inspect the replacement item. In the exemplary embodiment, if the insured user is satisfied with the replacement item, the insured user then accesses system 10 and approves 80 the transaction. If a pre-determined amount of time elapses without a response from the insured user, system 10 automatically bills the insurance provider. If the insured user is dissatisfied, the insured user then accesses system 10 to decline 82 the transaction and a shipper is notified to return the item.

If the user is an unregistered user and attempts to order a selected product, system 10 transmits a notification to the user indicating that a sales person or an authorized distributor will contact that individual to confirm the order request. System 10 then transmits (not shown) a notification, such as via email, to an approval member who follows-up with the unregistered user that submitted the order.

In the exemplary embodiment, system 10 generates 90 an events log that is populated with data during as each action is proposed and completed. Each events log is unique to the transaction occurring. More specifically, a new events log is populated each time system 10 receives 32 product specification information from at least one of an authorizing agent, a manufacturer, and a distributor, and each events log remains “active” until the user has acknowledged receipt of the replacement item and/or a cash settlement.

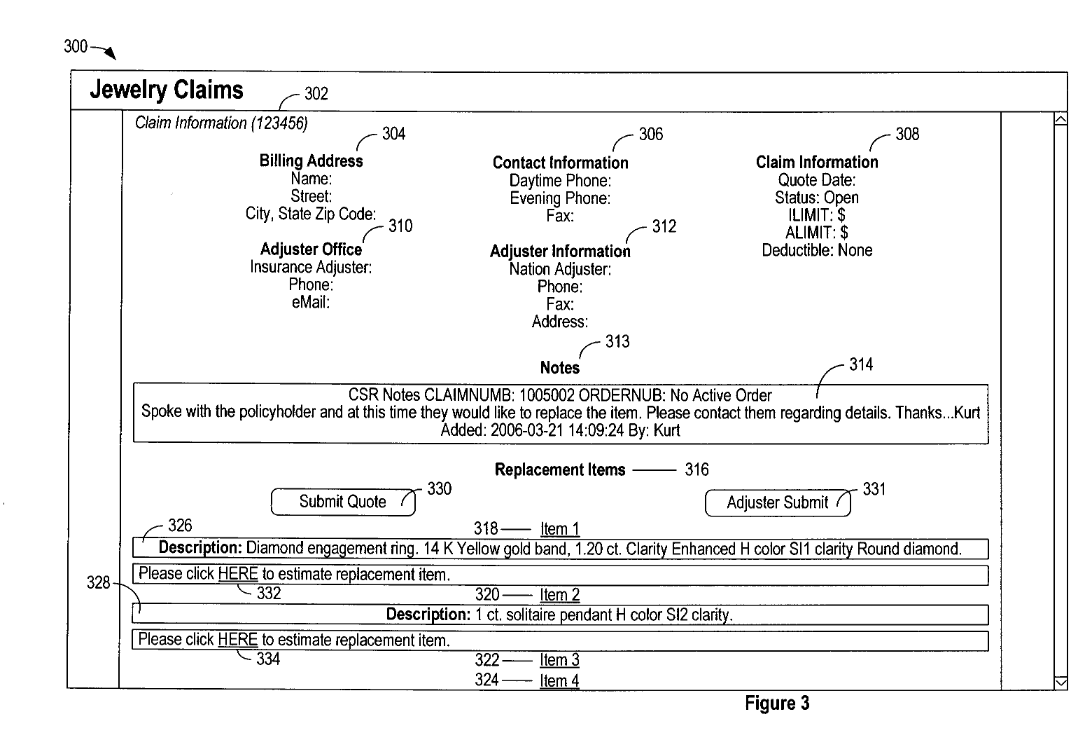

FIGS. 3 through 11 illustrate exemplary screen shots that may be used when navigating through an exemplary website linked to system 10 (shown in FIG. 1). In one exemplary embodiment, the website is linked to system 10 via a device 14 (shown in FIG. 1) when flowchart 30 (shown in FIG. 2) is implemented. More specifically, FIG. 3 is an exemplary jewelry claim profile page 300 that may be downloaded and displayed on device 14 by server 12 when a user is attempting to obtain additional information about available replacement items or jewelry.

In the exemplary embodiment, jewelry claim profile page 300 includes data information boxes 302, 304, 306, 308, 310, and 312 that enable information about a claim to be input. In the exemplary embodiment, the boxes 302, 304, 306, 308, 310, and 312 include boxes, such as, but not limited to, a claim identification number box 302, a “Billing Address” box 304, a “Contact Information” box 306, a “Claim Information” box 308, an “Adjuster Office Information” box 310, and an “Adjuster Information” box 312. Information about the claim may be input 31 by a user using, for example, device 14 and/or server 12. Alternatively, an insurance agent user or other user may input 31 information about the claim. In the exemplary embodiment, jewelry claim profile page 300 includes a “Notes” field 313 that includes a note box 314 that may be used to display notes pertaining to the claim. More than one note box 314 may be used in “Notes” field 313 to display more than one note. In the exemplary embodiment, notes may be entered by a user and/or an agent user, which may be an insurance agent, an insurance adjuster, or any other user acting as an agent.

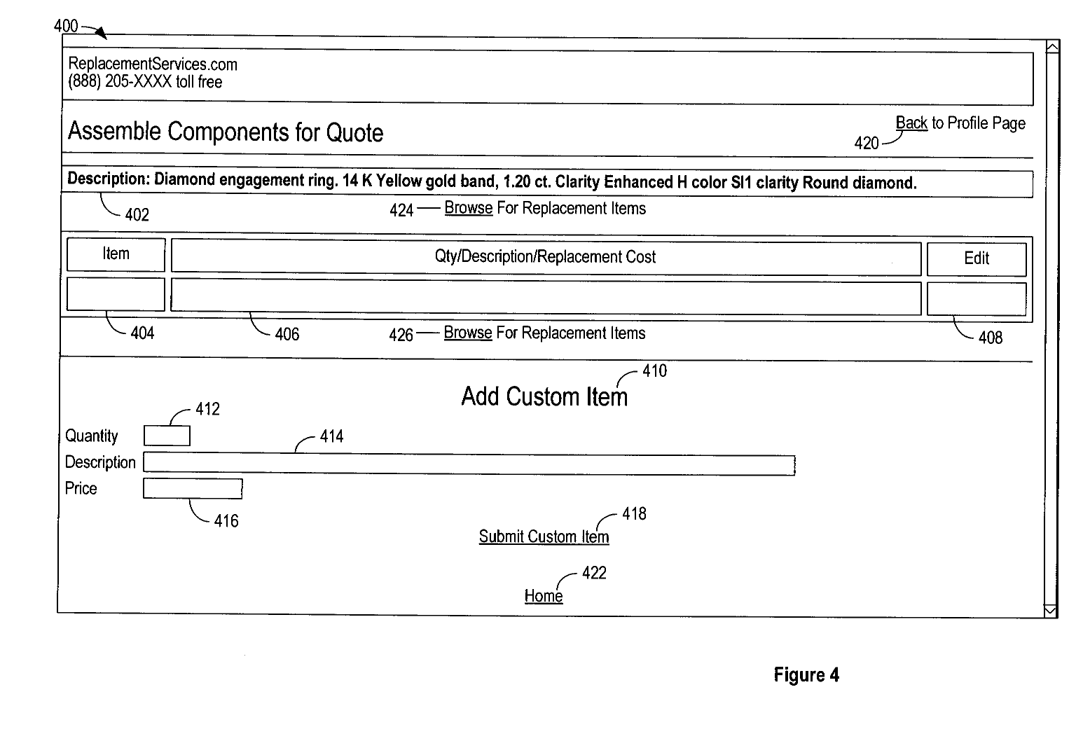

Furthermore, in the exemplary embodiment, jewelry claim profile page 300 includes a “Replacement Items” field 316. In the exemplary embodiment, “Replacement Items” field 316 includes one or more items to be replaced. For each item included with the claim, an “Item” hyperlink (hereinafter referred to as a “hyperlink” or a “link) 318, 320, 322, and 324 is displayed on page 300. In an alternative embodiment, more or less than four hyperlinks 318, 320, 322, and 324 may be displayed. Each “Item” link 318, 320, 322, and 324, populates a relevant portion, and links to an item quote worksheet 400 (shown in FIG. 4) for each item associated with the claim. Furthermore, for each item, a “Description” box 326 and 328, (for Items 1 and 2 respectively, in the exemplary embodiment) is displayed. More specifically, in the exemplary embodiment, the description for Item 1 is displayed in box 326, and the description for Item 2 is displayed in box 328. Such descriptions may be entered by a user or an agent user. The description information in boxes 326 and 328 may be the same as, or may be different from, the received 32 product specification information. In the exemplary embodiment, “Replacement Items” field 316 includes a “Submit Quote” button 330 that may be used to submit quote information to another user, such as, for example, an insurance agent or an insurance adjuster. Further, in the exemplary embodiment, “Replacement Items” field 316 includes an “Adjuster Submit” button 331 that may be used by the agent user, such as, an adjuster, to send, for example, via email, a summary of the quote including the comparables directly to an insured. As such, either the user or the agent user may transmit 160 the quote to the insured for review.

FIG. 4 is an exemplary quote worksheet page 400 that may be downloaded and displayed on device 14 by server 12 when a user desires to obtain additional information about available replacement items or jewelry. In the exemplary embodiment, quote worksheet page 400 may be accessed by selecting an “Item” link 318, 320, 322, or 324 from jewelry claim profile page 300. Quote worksheet page 400 may also be accessed by selecting a link 332 or 334 below “Description” boxes 326 and 328, respectively. Alternatively, quote worksheet page 400 may be accessed from jewelry claim profile page 300 by choosing, for example, a link, a selection box, a radio button, or any other mechanism that functions similarly.

In the exemplary embodiment, quote worksheet page 400 includes a “Description” box 402, an “Item” table 404, a replacement item description table 406, and an “Edit” table 408. The description information input into boxes 326 and 328 may be the same as the received 32 product specification information. Alternatively, the description information input into boxes 326 and 328 may different from the received 32 product specification information. More specifically, in the exemplary embodiment, replacement item description table 406 may display, for example, a quantity, a description, and/or a cost of a replacement item. Furthermore, in the exemplary embodiment, quote worksheet page 400 includes an “Add Custom Item” field 410. More specifically, “Add Custom Item” field 410 includes a “Quantity” entry box 412, a “Description” entry box 414, and a “Price” entry box 416. In the exemplary embodiment, “Add Custom Item” field 410 may be used to enter custom items, such as, the cost of labor and/or custom mountings. More specifically, to add a custom item, information is input into entry boxes 412, 414, and 416 by a user or an insurer, and a “Submit Custom Item” link 418 is selected to enter custom item information into device 14 and/or server 12. In the exemplary embodiment, quote worksheet page 400 includes a link 420 that directs the user back to jewelry claim profile page 300, a link 422 to direct the user to a home page (not shown), and links 424 and 426 to direct the user to “Browse for Replacement Items”.

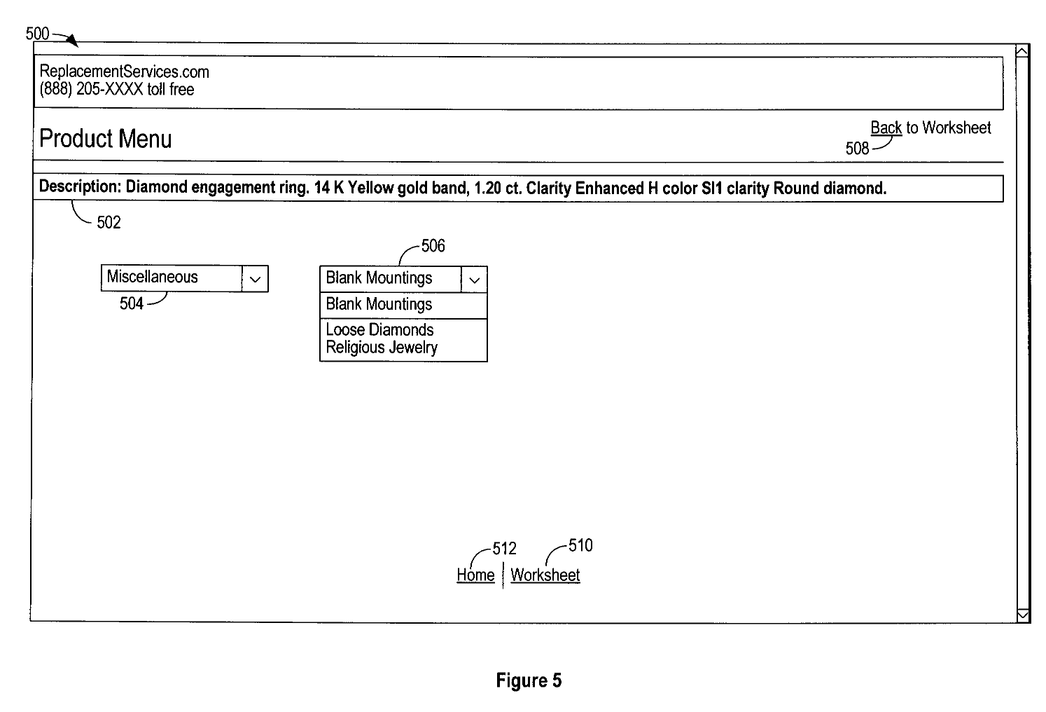

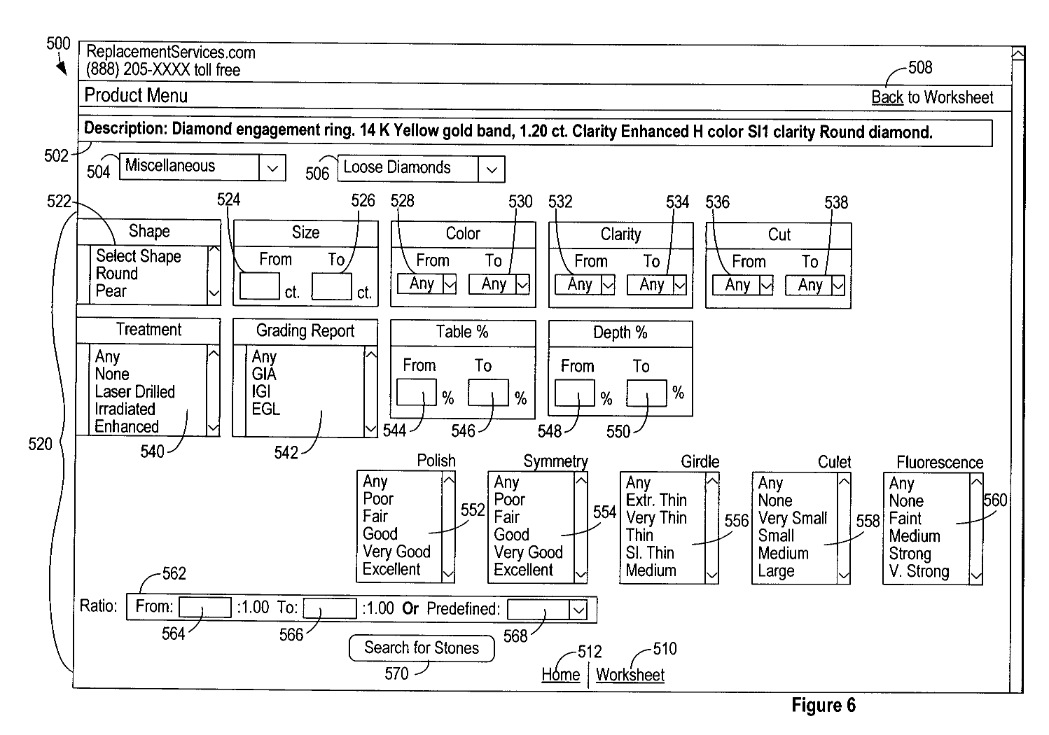

FIG. 5 is an exemplary product menu selection page 500 that may be downloaded and displayed on device 14 by server 12 when a user elects to obtain additional information about available replacement items or jewelry. FIG. 6 is an exemplary product menu page 500 displaying search fields 520 for selecting loose diamonds. In the exemplary embodiment, product menu page 500 includes a “Description” box 502, and pull-down menus 504 and 506 for selecting the type of product or item to be replaced. Alternatively, more or less than two menus 504 and 506 may be included on product menu page 500. In the exemplary embodiment, the description information displayed in “Description” box 502 is the same description information displayed on jewelry claim profile page 300 and/or quote worksheet page 400. Alternatively, the description information may be displayed differently on each of pages 300, 400, and 500.

In the exemplary embodiment, the product type is selected from menu 504, and then the item type is selected from menu 506. Menu 504 may include, for example, selections such as, but not limited to, rings, men's jewelry, bracelets, earrings, pendants, necklaces, miscellaneous, and finished jewelry. For example, in the exemplary embodiment, if “Miscellaneous” is selected from menu 504, menu 506 may include, selections, such as, but not limited to, blank mountings, loose diamonds, and religious jewelry. Specifically, in the exemplary embodiment, item selections included in menu 50 to trigger appropriate selections in menu 506 that are associated with the items selected in menu 504. In the exemplary embodiment, product menu page 500 also includes links 508 and 510 that direct the user to quote worksheet page 400, and a “Home” link 512 that directs the user to the home page.

In the exemplary embodiment, when “Loose Diamonds”, for example, is selected in menu 506, loose diamond search fields 520 are displayed on product menu page 500. Specifically, search fields are provided in menu 506 for each user selection from menu 504. In the exemplary embodiment, search fields 520 include, for example, but are not limited to only including, a “Shape” scroll menu 522, “Size” entry boxes 524 and 526, “Color” pull-down menus 528 and 530, “Clarity” pull-down menus 532 and 534, “Cut” pull-down menus 536 and 538, “Treatment” scroll menu 540, “Grading Report” scroll menu 542, “Table %” entry boxes 544 and 546, “Depth %” entry boxes 548 and 550, “Polish” scroll menu 552, “Symmetry” scroll menu 554, “Girdle” scroll menu 556, “Cutlet” scroll menu 558, and “Fluorescence” scroll menu 560. In the exemplary embodiment, search field 520 also includes a “Ratio” field that includes entry boxes 564 and 566 and a pull-down menu 568. Boxes 564 and 566 may be used to enter a numerator and a denominator, respectively, of a stone ratio. Pull-down menu 568 may alternatively be used to select a stone ratio. Alternatively, other combinations of scroll menus, pull-down menus, entry boxes, check boxes, and/or other data entry ports, may be used to enter search criteria.

Information may be input into one or more search fields 520 depending on the item to be replaced. In the exemplary embodiment, once search criteria is entered into search fields 520, the “Search for Stones” button 570 is selected to compare 34 the search criteria input with information stored on a database within server 12. Alternatively, search criteria may be compared to a database within device 14 or within a remote database (not shown).

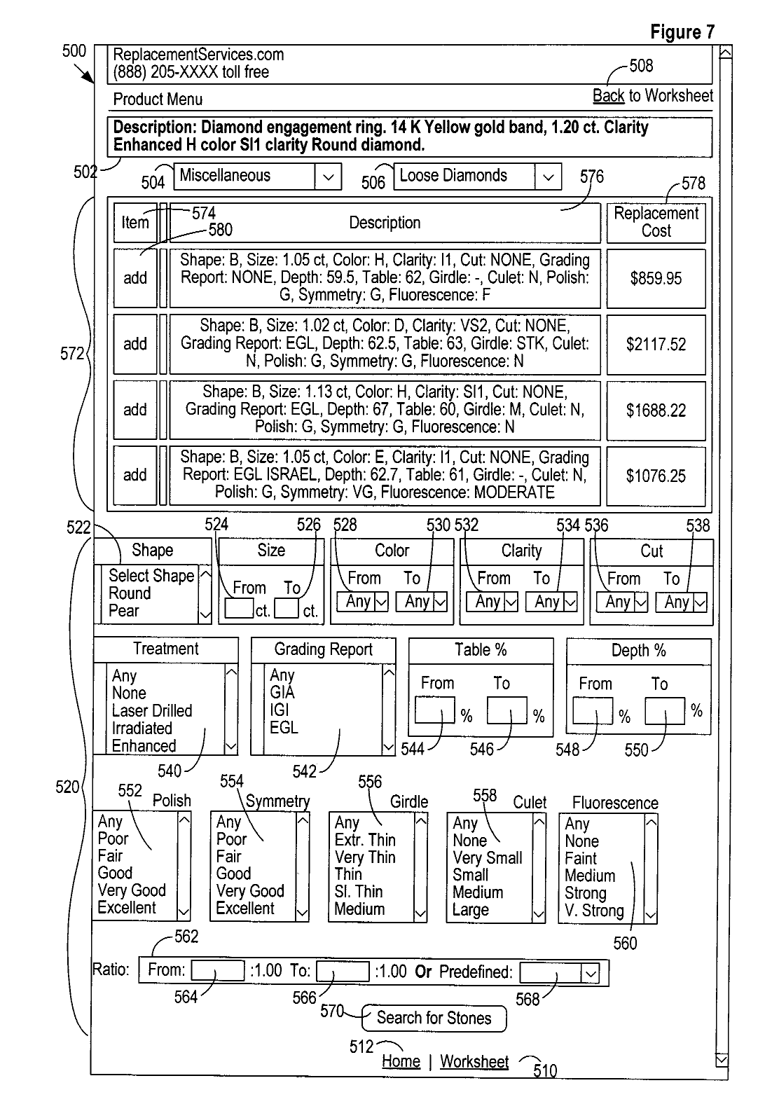

FIG. 7 is an exemplary search product menu page 500 that may be used to display results obtained from comparing 34 search criteria with pre-stored information on a database. More specifically, in FIG. 7, exemplary search results are shown for a round diamond, as entered in menu 522, and that is sized between 1 carat and 2 carats, as entered in entry boxes 524 and 526. In the exemplary embodiment, search fields 520 remain visible on page 500 such that search criteria may be altered in search fields 520 to obtain other search results. In the exemplary embodiment, search results are displayed in a results field 572. Search results field 572 includes tables 574, 576, and 578, such as, but not limited to including, an “Item” table 574, a “Description” table 576, and a “Replacement Cost” table 578, to display information about replacement items. Alternatively, search results field 572 may display information other than in table form. Furthermore, in another exemplary embodiment, other information and/or item information, description information, and replacement cost information may be displayed.

In the exemplary embodiment, “Description” table 576 includes information pertaining to each comparable replacement item, such as, but not limited to including, information associated with shape, size, color, clarity, cut, grading report, depth, table, girdle, cutlet, polish, symmetry, and fluorescence. Furthermore, in the exemplary embodiment, “Replacement Cost” table 578 includes a replacement cost for each item in “Description” table 576. In the exemplary embodiment, “Item” table 574 includes an “Add” link 580 for each replacement item in “Description” table 576. When “Add” link 580 is selected for a comparable item, the item is downloaded to device 14 and/or server 12 to be displayed on quote worksheet page 400, as described in more detail below. In the exemplary embodiment, zero or more comparable replacement items may be selected using a respective “Add” link 580 for a desired replacement item.

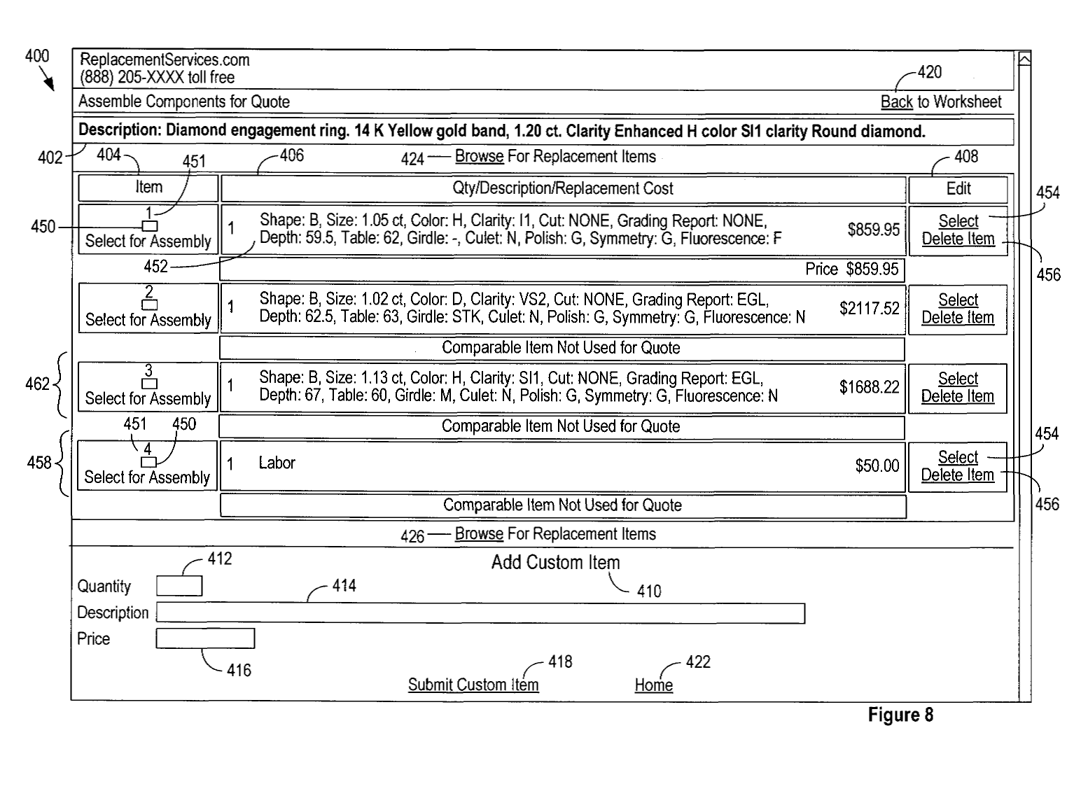

FIG. 8 is an exemplary quote worksheet page 400 that may be used to display comparable replacement items as selected from product menu page 500. In the exemplary embodiment, quote worksheet page 400 includes data that populates “Item” table 404, replacement item description table 406, and/or “Edit” table 408. Specifically, “Item” table 404 includes a “Select for Assembly” checkbox 450 with an associated item number 451 for each comparable replacement item replacement item. Furthermore, description table 406 includes a description 452 for each replacement item, and “Edit” table 408 includes a “Select” link 454 and a “Delete Item” link 456 for each corresponding replacement item. More specifically, in the exemplary embodiment, description 452 is the same as, or different from, the description information displayed in “Description” table 576 (shown in FIG. 7).

In the exemplary embodiment, for example, a custom item entry 458 is displayed in tables 404, 406, and 408. Specifically, custom item entry 458 is created by inputting “1” in “Quantity” entry box 412, “Labor” in “Description” entry box 414, and “50.00” in “Price” entry box 416. Custom item entry 458 includes a “Select for Assembly” checkbox 450 and item number 451 of “4” in “Item” table 404; “1”, “Labor”, and “50.00” in “Description” table 406 to correspond to information inputted into entry boxes 412, 414, and 416; and a “Select” link 454 and a “Delete Item” link 456 in “Edit” table 408.

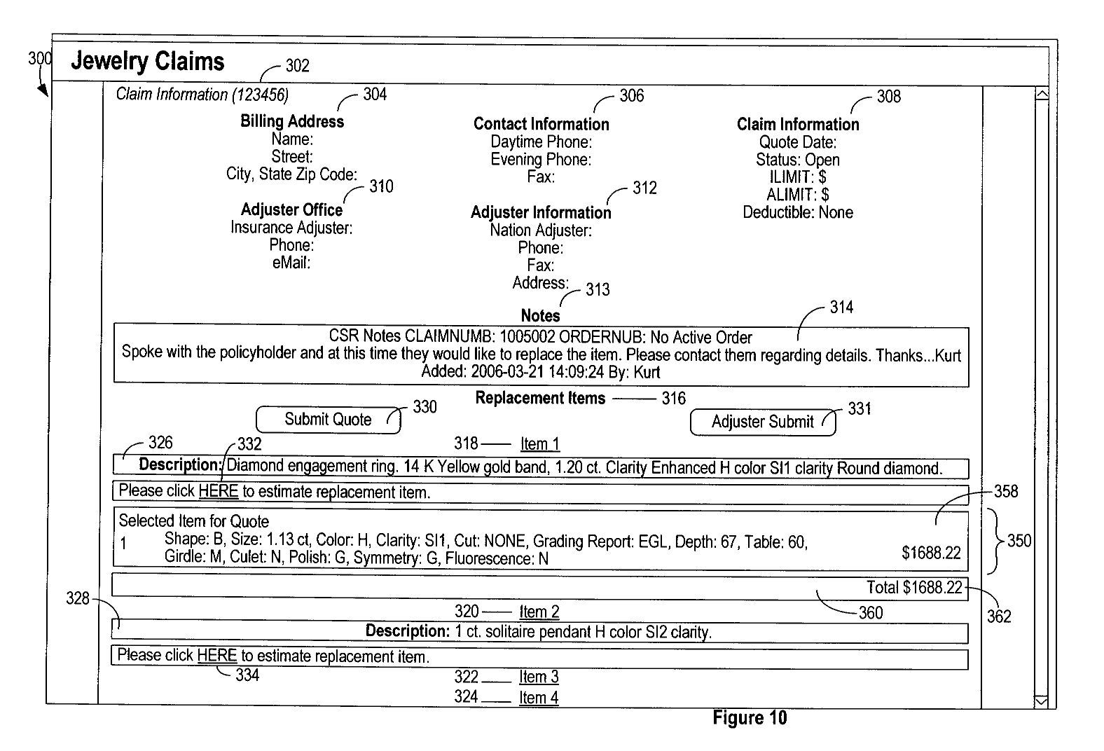

In the exemplary embodiment, for a user to select a comparable replacement item to transmit 152 a quote to another user, for example, an insurance agent, the user selects the corresponding “Select” link 454 for the desired replacement item. Information relating to the comparable replacement item is downloaded to device 14, server 12, and/or other database, to be displayed on jewelry claim profile page 300, as described in more detail below and shown in FIG. 10.

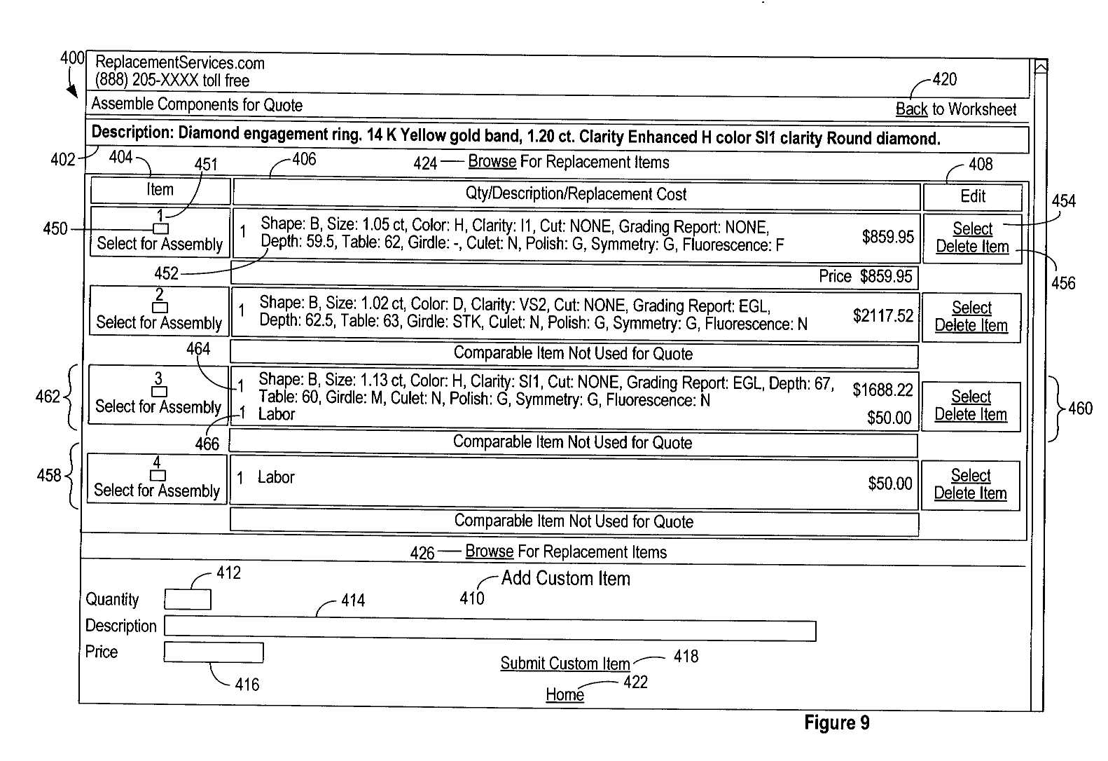

FIG. 9 is an exemplary quote worksheet page 400 that may be used to display comparable replacement items and an assembly 460. In the exemplary embodiment, for example, an assembly of comparable replacement items may by used to generate 148 a replacement quote. In an exemplary example, “Browse for Replacement Items” link 424 or 426 may be selected to direct the user back to product menu page 500 to select another type of replacement product or item, such as, but not limited to, a blank mounting, a blank setting, a chain, a watch, or other item associated with an item that is the subject of the claim, that may be added to any other item shown in tables 404, 406, and 408.

To assemble items displayed in tables 404, 406, and 408, a corresponding “Select for Assembly” checkbox 450 is selected for the replacement item to which at least one other replacement item will be added. For example, in the exemplary embodiment, Item 3 in box 462 (shown in FIG. 8) is added to by selecting a corresponding checkbox 450 for Item 3, and then by selecting a checkbox 450 that corresponds to an additional item. More specifically, in the exemplary embodiment, for example, to add labor costs to Item 3 in box 462, checkbox 450 corresponding to custom item 458 is selected. In the exemplary embodiment, upon selecting a second checkbox 450, assembly 460 is created and displayed in tables 404, 406, and 408. More specifically, in the exemplary embodiment, Item 3 in box 462 displays a main item description 464 and an additional item description 466. and the additional item, custom item 458, remains in tables 404, 406, and 408 as an individual item. Alternatively, both the main item and the additional item remain in tables 404, 406, and 408 as separate items, and a new row is added to tables 404, 406, and 408 to display assembly 460. In one embodiment, more than two items are selected to create an assembly by choosing the main item and an additional item, then choosing the assembly and another additional item until the assembly is complete. In another exemplary embodiment, several checkboxes 450 may be selected at one time and then assembled.

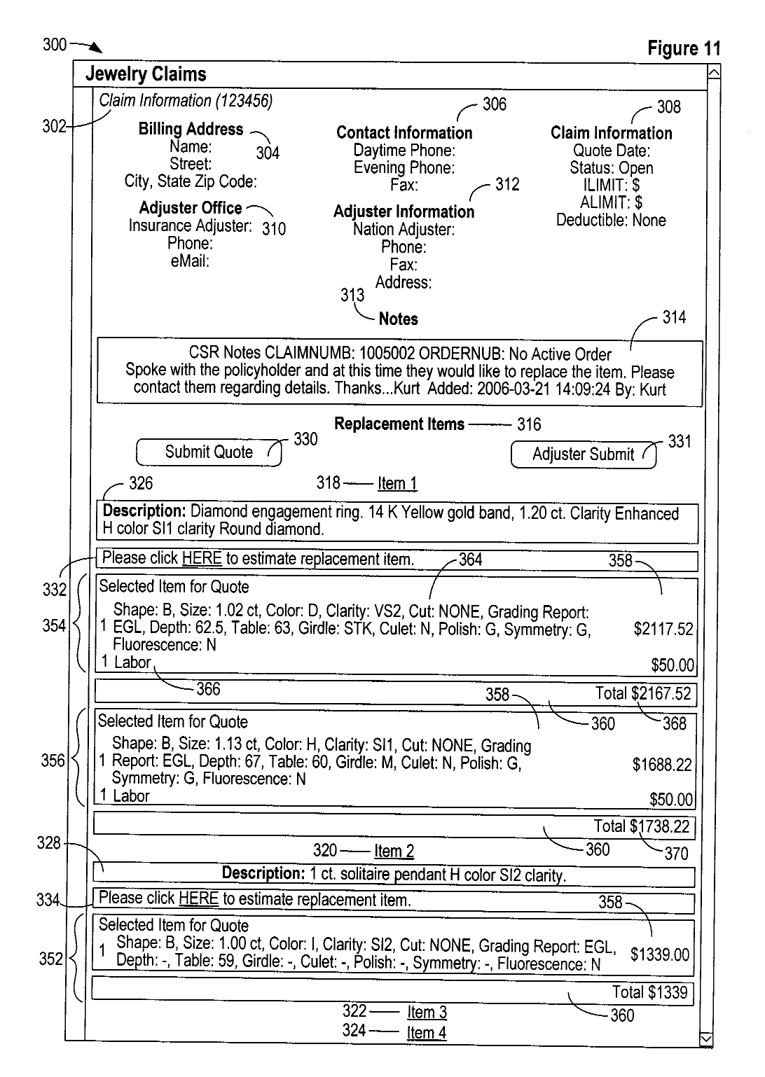

To choose an assembly to for a replacement quote, “Select” link 454 is selected for the comparable replacement assembly. The selected assembly is then downloaded to device 14, server 12, and/or another database to be displayed on jewelry claim profile page 300, as described below in more detail and shown in FIG. 11. Alternatively, more than one comparable assembly may be created using replacement items displayed in tables 404, 406, and 408.

FIG. 10 is exemplary jewelry claim profile page 300 that may be used to display a replacement item 350 as selected on quote worksheet page 400. FIG. 11 is exemplary jewelry claim profile page 300 that may be used to display a replacement item 352 and replacement assemblies 354 and 356 as selected on quote worksheet page 400. In the exemplary embodiment, for each insured item, such as Item 1, when a comparable replacement item, such as Item 3 displayed in box 462, is selected by using “Select” link 454 on quote worksheet page 400, information about the selected item is downloaded and displayed on jewelry claim profile page 300 in “Replacement Items” field 316 under corresponding insured Item 1. More specifically, in the exemplary embodiment, a description box 358 displays information, such as, but not limited to, a quantity, a description, and/or a price, for each comparable item. In the exemplary embodiment, the information displayed in description box 358 is the same as, or differently from, the information in replacement item description table 406 on page 400.

Furthermore, in the exemplary embodiment, “Replacement Items” field 316 includes a price quote box 360 that has a price quote 362 displayed therein. In the exemplary embodiment, price quote box 360 is located, for example, under each corresponding item description box 358. Alternatively, replacement item information may be displayed on page 300 other then in boxes 358 and 360. Although only one replacement item description box 358 and corresponding price quote box 360 is displayed in “Replacement Items” field 316 for Item 1, more than one replacement item description box 358 and price quote box 360 may be displayed on page 300 by selecting more than one replacement item from quote worksheet page 400, as described above.

In the exemplary embodiment, when an assembly, such as assembly 460, is selected as a comparable replacement item on worksheet page 400 for an insured item, such as Item 1, replacement assembly information is downloaded and displayed on jewelry claim profile page 300. More specifically, information about each selected comparable assembly 354 and 356 is displayed in respective description boxes 358 and price quote boxes 360 located under each respective “Description” box 326. Alternatively, assembly information may be displayed on page 300 other then in boxes 358 and 360. In the exemplary embodiment, description box includes a main replacement item description 364 and an additional replacement item description 366, where descriptions 364 and 366 are the same as, or different from, descriptions 464 and 466 displayed on page 400. Alternatively, assembly information may be displayed other than by separate descriptions for each item of the assembly. Although two replacement assemblies 354 and 356 are displayed on page 300 for insured Item 1, more or less than two replacement assemblies may be displayed for insured Item 1 depending on the selections made on worksheet page 400. In another exemplary embodiment, for example, at least one replacement item and at least one replacement assembly are displayed as replacement products for an insured item.

In the exemplary embodiment, for each assembly 354 and 356, each price quote box 360 displays an assembly price quote 368 and 370, respectively. In the exemplary embodiment, price quote 368 is the sum price for all items in assembly 354, and price quote 370 is the sum price for all items in assembly 356.

Furthermore, in the exemplary embodiment, for each item associated with the claim and displayed in “Replacement Items” field 316, comparable items are selected using pages 400 and 500, as described above. More specifically, in the exemplary embodiment, a replacement item 352 is displayed under insured Item 2 “Item” link 320 as a comparable replacement for the insured item displayed in “Description” box 328 for Item 2. Replacement item 352 includes a description box 358 and a price quote box 360, as described above. Alternatively, one or more items and/or assemblies may be displayed under “Description” box 328 as comparable replacement items for the insured Item 2.

In the exemplary embodiment, once comparable replacement item(s) and/or comparable replacement assembl(ies) have been selected for all insured items, “Submit Quote” button 330 is selected to transmit 152 information, such as, but not limited to, claim information, replacement item information, and price quote information, via device 14 and/or server 12 to another user, such as an insurance agent. The insurance agent may use the information to settle the claim with an insured. Alternatively, once comparable replacement item(s) and/or comparable replacement assembl(ies) have been selected for all insured items, “Adjuster Submit” button 331 is selected by, for example, an agent user, to transmit 160 information, such as, but not limited to, claim information, replacement item information, and price quote information, via device 14 and/or server 12 to another user, such as an insured.

System 10 facilitates an easy and efficient method for identifying and ordering items to replace insured items. System 10 is network based and is configured to permit users to access system 10 from remote locations through devices 14.

Exemplary embodiments of systems that facilitate replacement of insured items are described above in detail. The systems are not limited to the specific embodiments described herein, but rather, components of each assembly may be utilized independently and separately from other components described herein. For example, each system component and/or the methodology described above can also be used in combination with other insurance replacement systems and methodology.

While the invention has been described in terms of various specific embodiments, those skilled in the art will recognize that the invention can be practiced with modification within the spirit and scope of the claims.

What is claimed is:

1. A method for replacing insured items using a web-based system including a server and at least one device connected to the server via a network, said method comprising the steps of:
receiving at the server, from an insurer, specification information about the item to be replaced;
comparing the received item specification information with potential replacement product information pre-stored within at least one of the server and a database;
selecting at least one potential replacement product which substantially matches the received item specification information;
downloading item feature information, product accessory information, and a price quote related to the selected potential replacement product; and
determining a settlement price for the insured item based on at least one of the potential replacement products, whose information was downloaded.

2. A method in accordance with claim 1 further comprising:
pre-approving by the insurer at least one of:
at least one of the potential replacement products, whose information was downloaded; and
the settlement price for the insured item;
if pre-approving by the insurer of the settlement price for the insured item then:
receiving a user selection representing at least one of a compatible product and a cash-out option based on the settlement price approved by the insurer; and
if pre-approving by the insurer of at least one of the potential replacement products then:
providing the downloaded item feature information to the insured user; and
prompting the insured user to select at least one replacement item from the downloaded information.

3. A method in accordance with claim 1 wherein selecting at least one potential replacement product which substantially matches the received item specification information comprises selecting at least one potential replacement product that is at least one of a component or an assembly of components.

4. A method according to claim 1 wherein providing the downloaded item feature information to the insured user comprises providing a settlement price to the insured user, wherein the settlement price is based on the selected potential replacement quotes.

5. A method according to claim 1 further comprising guiding the user to a compatible product which substantially matches the received item specification information.

6. A method in accordance with claim 1 further comprising receiving a user selection representing a compatible product.

7. A method in accordance with claim 1 wherein said step of selecting at least one potential replacement product comprises selecting at least one one potential replacement product which substantially matches the received item specification information for each insured item of a claim.

8. A method in accordance with claim 1 further comprising maintaining an event log including actions taken on behalf of at least one of the insured user and the insurer.

9. A method in accordance with claim 1 wherein receiving specification information about the item further comprises comparing the item specification information with pre-stored information.

10. A method in accordance with claim 1 wherein receiving specification information about the item further comprises using the item specification information to download information related to products which substantially match the item specification information.

11. A system for facilitating selection of an item by an insured user to replace an insured item of the insured user, said system comprising:
a device; and
a server coupled to said device, said server configured to receive specification information data from an insurer about the item to be replaced via said device, wherein the specification information includes at least one of a feature of the item, an accessory of the item, and a price quote, said server further configured to:
identify stored product information data that substantially matches item specification information data entered into the server;
download potential replacement product information; and
determine a settlement price for the insured item based on at least one of the potential replacement products, whose information was downloaded.

12. A system in accordance with claim 11 wherein said server further configured to:
prompt the insured user to pre-approve at least one of:
at least one of the potential replacement products, whose information was downloaded; or
the settlement price for the insured item;
if the insured user pre-approves the settlement price for the insured item, then said server configured to:
receive a user selection representing at least one of a compatible product and a cash-out option based on the settlement price approved by the insurer; and
if the insured user pre-approves at least one of the potential replacement products, then said server further configured to:
provide the downloaded item feature information to the insured user; and
prompt the insured user to select at least one replacement item from the downloaded information.

13. A system in accordance with claim 11 wherein said server further configured to prompt the insurer to pre-approve a settlement price for the insured item based on at least one of the potential replacement products, whose information was downloaded.

14. A system in accordance with claim 11 wherein said server further configured to prompt a user to assemble stored product information data into at least one compatible replacement product.

15. A system in accordance with claim 11 wherein said server further configured to display to the user a compatible product which substantially matches the received item specification information.

16. A system in accordance with claim 11 wherein said server further configured to receive from a user a selection representing a compatible product, wherein said selection is at least one of a component and an assembly of components.

17. A system in accordance with claim 11 wherein said server further configured to provide potential replacement product information for each item of a claim.

18. A system in accordance with claim 11 wherein said server further configured to generate an events log including actions taken on behalf of at least one of the insured user and the insurer.

19. A system in accordance with claim 11 wherein said server further configured to compare the item specification information entered with pre-stored information.

20. A system in accordance with claim 11 wherein said server further configured to download potential replacement product information, wherein the potential replacement product is available for sale at the time of the download.
